(19) United States
(12) Patent Application Publication
(10) Pub. No.: US 2013/0091008 A1
(43) Pub. Date: Apr. 11, 2013

(54) System and method of interaction

(71) Applicant: Mikhail Leonidovich Liubachev, Saint-Petersburg (RU)

(72) Inventor: Mikhail Leonidovich Liubachev, Saint-Petersburg (RU)

(21) Appl. No.: 13/689,763

(22) Filed: Nov. 30, 2012

Related U.S. Application Data
(60) Provisional application No. 61/697,311, filed on Sep. 6, 2012.

(51) Int. Cl. G06Q 30/02

(52) U.S. Cl. CPC G06Q 30/0242
USPC 705/14.41

(57) ABSTRACT

A computer implemented method of interaction between first user working at the first computer system and second user, working at the second computer system, said first and second computer systems can intercommunicate with each other by means of communication modules, said method comprising the following steps: obtaining information, at a first computer system, about first user interaction with one or more computer programs and with corresponding data, stored at the first computer system; sending to the second computer system, all or part of the information about the first user interaction with one or more programs and corresponding data; receiving, all or part of the information about the first user interaction with one or more programs and corresponding data; analyzing all or part of the received information; choosing one of the preliminarily created scenarios or politics of further promotion or development of products or services on the base of performed analysis.

### FIELD OF INVENTION

This invention relates to the systems serving marketing activity and, in particular, to systems and methods of interaction between companies and customers during the process of product or service promotion via electronic devices.

### RELATED ART

Companies use a variety of systems and methods to promote their goods and services. Some of them offer discounts on their website. For example, Groupon® offers discount coupons on their website, http://www.groupon.com. These discount offers are updated every day. These discounts can be for various things, from houses and apartments to notarial and cleaning services. Typically, these promo-campaigns are limited-period offers, which mean that the coupons cannot be used to purchase discounted goods or services after a certain period of time. Depending on the type of offer, a coupon can usually be used anywhere from one to three months. Additionally, the customer needs to call the company and notify them of the day on which he or she will be able to physically visit them to purchase goods and/or services from them.

If a customer wants to purchase discounted goods or services on such websites, he or she typically will need to click on the company website, fill in a credit card number or the number of some other method of payment (for example, a PayPal® account), to pay for the offer. Finally, he or she will need to print the coupon.

There are several disadvantages to this method of operation.

First, the company that creates the discount offer and posts it on the website possesses only a limited amount of information about customers' activity. In particular, the company has information only about the amount of coupons that were purchased and the total number of coupons.

As a result, the company does not obtain valuable information about:
customers who were interested in the offered goods and/or services, but didn't buy anything.
how much time the potential customer spent reading the offer description.
whether the potential customer looked at the pictures of the offer.
whether the potential customer intended to buy a coupon, but didn't buy it.
whether the potential customer wanted to buy more than one coupon, but did not buy more, etc.

If it possessed this information, the company could improve its marketing and R&D activities. For example, if a large number of potential customers left the promo-campaign description without purchasing coupons, this could mean that the goods or services offered by the company were not suitable for them.

There can be several reasons for this:
the price of goods or services is very high, even with the discount, or
potential customers want to have the goods or services delivered, but the company does not have delivery options, or
customers have a wrong perception of the product, etc.

There can be a lot of reasons why potential customers have not purchased goods or services. At present, companies can't get such information from their websites, and, therefore, cannot improve their advertisements or products.

Secondly, companies don't have the ability to participate in the purchase process. For example, company representatives can't track when potential customers begin to review offers from their company and so cannot send a message to potential customers.

### SUMMARY OF THE INVENTION

In accordance with some embodiments of the present invention, a computer implemented method of interaction between first user working at the first computer system and second user, working at the second computer system, said first and second computer systems can intercommunicate with each other by means of communication modules, said method comprising the following steps: obtaining information, at a first computer system, about first user interaction with one or more computer programs and with corresponding data, stored at the first computer system; sending to the second computer system, all or part of the information about the first user interaction with one or more programs and corresponding data; receiving, all or part of the information about the first user interaction with one or more programs and corresponding data; analyzing all or part of the received information; choosing one of the preliminarily created scenarios or politics of further promotion or development of products or services on the base of performed analysis.

In accordance with some embodiments of the present invention, A system for communication comprising: a first computer system and a second computer system; wherein the first computer system further comprising: one or more processors; a device for storing data; a communication module; one or more programs, created or distributed by a user of the second computer system; wherein one or more programs of the first computer system are stored in the device for storing data of the first computer system and configured to be executed by one or more processors of the first computer system, one or more programs of the first computer system containing instructions for: obtaining information about first user interaction with one or more programs and with corresponding data; sending, by means of a communication module of the first computer system, all or part of the information about first user interaction with one or more programs of the first computer system and with corresponding data to the second computer system, wherein the second computer system comprising: one or more processors; a device for storing data; a communication module; one or more programs, wherein the one or more programs of the second computer system are stored in the device for storing data of the second computer system and configured to be executed by the one or more processors of the second computer system, the one or more programs of the second computer system containing instructions for: receiving, by means of a communication module of the second computer system, all or part of the information about first user interaction with one or more programs of the first computer system and with corresponding data; analyzing all or part of the received information.

In accordance with some embodiments of the present invention, A system for communication comprising: a first computer system group, a second computer system, wherein the first computer system group comprising two or more computer systems; wherein each computer system from the first computer system group comprises at least the following elements: one or more processors #1; one or more devices for storing data #1; one or more communication modules #1; one or more programs #1, which are created or distributed by a user of the second computer system; wherein the one or more programs #1 are stored in one or more devices for storing data #1 and configured to be executed by the one or more processors #1, the one or more programs #1 containing instructions for: establishing a network connection, by means of the one or more communication modules #1 to one or more computer systems from the first group; obtaining information about one or more users of the one or more computer systems from the first computer system group interaction with one or more programs #1 and with corresponding data; sending, from one or more computer systems from the first group and by means of the one or more communication modules #1 all or part of the information about the users of the one or more computer systems from the first computer system group interaction with one or more programs #1, corresponding data and information about first computer group connections to the second computer system group; wherein the second computer system comprises at least the following elements: one or more processors #2; one or more devices for storing data #2; one or more communication modules #2; one or more programs #2; wherein the one or more programs #2 are stored in the one or more devices for storing data #2 and configured to be executed by the one or more processors #2, the one or more programs #2 containing instructions for: receiving, by means of the one or more communication modules #2 of the second computer system, all or part of the information about one or more users of the one or more computer systems from the first computer system group interaction with one or more programs #1 of the first computer system group, corresponding data and information about first computer group connections; analyzing all or part of the received information.

### BRIEF DESCRIPTION OF THE DRAWINGS

For a better understanding of the aforementioned embodiments of the invention as well as additional embodiments thereof, reference should be made to the detailed description below, in conjunction with the following drawings in which like reference numerals refer to corresponding parts throughout the figures.

FIG. 1 shows the consequence of steps of the method for communication between the company and customers, according to some embodiments.

FIG. 2 illustrates the elements of the system for communication between the company and customers, according to some embodiments.

FIG. 3 illustrates an example of the graphical user interface, which might be shown to the user of the first computer system, according to some embodiments of the present invention.

FIG. 4 illustrates an example of the graphical user interface, which is shown to the user of the second computer system, according to some embodiments of the present invention.

FIG. 5 illustrates an example of the table which might be used for the representation of the objects of the information on the second computer system in accordance with some embodiments of the present invention.

FIG. 6 illustrates an example of the graphical user interface, which is shown to the user of the second computer system after the second computer system receives the first group of objects of the information from the first computer system, according to some embodiments of the present invention.

FIG. 7 illustrates an example of the graphical user interface, which is shown to the user of the second computer system after the second computer system receives the second group of objects of the information from the first computer system, according to some embodiments of the present invention.

FIG. 8 shows an example of the graphical user interface which might be shown to the user of the first computer system in accordance with some embodiments of the present invention.

FIG. 9 shows an example of the graphical user interface which might be shown to the user of the first computer system in accordance with some embodiments of the present invention.

FIG. 10 illustrates an example of the graphical user interface, which is shown to the user of the second computer system after the second computer system receives the third group of objects of the information from the first computer system, according to some embodiments of the present invention.

FIG. 11 illustrates an example of the graphical user interface, which is shown to the user of the second computer system after the second computer system receives the fourth group of objects of the information from the first computer system, according to some embodiments of the present invention.

FIG. 12 shows the mechanisms of communication between the first computer system and the second computer system, according to some embodiments of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first gesture could be termed a second gesture, and, similarly, a second gesture could be termed a first gesture, without departing from the scope of the present invention.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the system and method of communication between the company and customers are described.

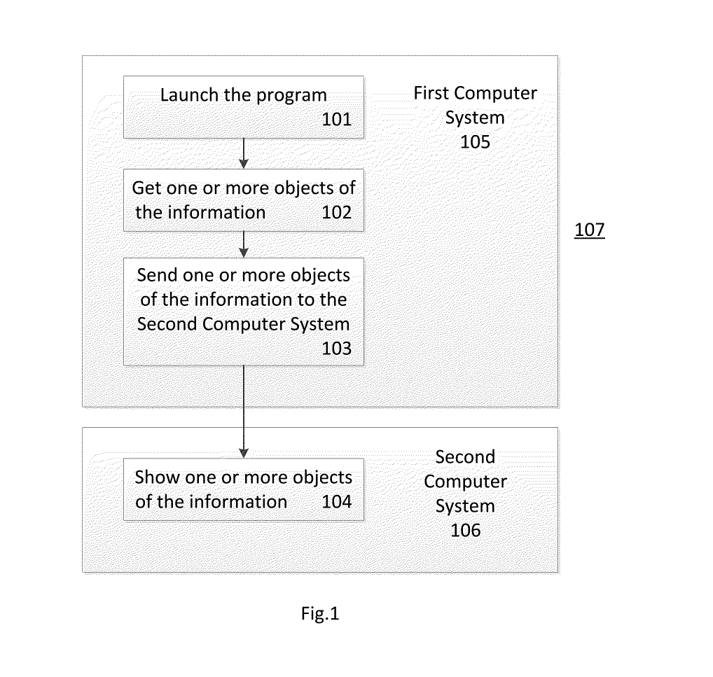

FIG. 1 is a block diagram illustrating the method of communication in accordance with one embodiment of the present invention. The method 107 may be performed by a processing logic that may comprise hardware (circuitry, dedicated logic, etc.), software (such as is run on a general purpose computer system or a dedicated machine), or a combination of both. In one embodiment, the method 107 includes launching the program 101 on the first computer system 105, the program capable of collecting objects of the information, and transmitting the data.

After the program has launched 101 on the First Computer System, the program collects one or more objects of the information 102 from the First Computer System 105. Objects of the information may include, but are not limited to, text message, cellphone number, program logs, time, date, information about user of the First Computer System 105, information about user of the Second Computer System 106, geographical location of the First Computer System 105, geographical location of the Second Computer System 106, configuration of the First Computer System 105, configuration of the Second Computer System 106, serial number of the First Computer System 105, serial number of the Second Server 106, user first and last name, user address, user age, user sex, user work experience, information about friends of the user, etc.

After the program collects one or more objects of the information 102, the program sends the said one or more objects of the information 103 to the Second Computer System 106. In some embodiments, the program may establish a network connection between First Computer System 105 and Second Computer System 106 before sending the said one or more objects of the information. In some embodiments, the program may create a network pool between the First Computer System 105 and the Second Computer System 106. The said one or more objects of the information may be transferred from the First Computer System to the Second Computer System in one or more parts and in different time. For example, first part of the said one or more objects of the information can be transferred today, other parts tomorrow. The First Computer System 105 and the Second Computer System 106 may be located in same and/or different networks and/or in the Internet. In some embodiments, the First Computer System 105 may save the said one or more object of the information to the database and/or high-speed random access memory and/or non-volatile memory, such as one or more magnetic disk storage devices, flash memory devices, or other non-volatile solid-state memory devices. The said database may be located in the First Computer System 105 and/or Second Computer System 106 and/or in the Internet and/or other types of a network. In some embodiments, some parts of the said one or more objects of the information may be saved in the database, other parts in the memory of the First Computer System 105. In some embodiments, some parts may be saved in the memory and/or in the database of the First Computer System 105, other parts in the memory and/or in the database of the Second Computer System 106.

Upon receiving on the Second Computer System 106, the said one or more objects of the information, the Second Computer System 106 will show the said one or more objects of the information to the user. In some embodiments Second Computer System 106 will show the said one or more objects of the information using a display device, such as a monitor, a display of a first computer system, a touch-screen display of a first computer system, a display of a laptop, a touch-screen display of a laptop, a display of a cellphone, a display of a smartphone, a touch-screen display of a cellphone, a touch-screen display of a smartphone, a television screen, a display of a tablet PC, a touch-screen display of a tablet PC. In some embodiments, the Second Computer System 106 may save the said one or more objects of the information to the database and/or high-speed random access memory and/or nonvolatile memory, such as one or more magnetic disk storage devices, flash memory devices, or other nonvolatile solid-state memory devices. The said database may be located in the First Computer System 105 and/or Second Computer System 106 and/or on the Internet. In some embodiments, not all objects of the information are shown to the user of the Second Computer System 106. In some embodiments, a part of the said one or more objects of the information is shown to the user of the Second Computer System 106 and another part is saved to the database or to high-speed random access memory or nonvolatile memory. In some embodiments, the Second Computer System 106 shows one part of the said one or more objects of the information and deletes another part of the said one or more objects of the information.

It should be appreciated that this method of communication using two computer systems is only one example of the implementation of the method for communication, and that the method may use additional computer systems and/or data storage for transfer of the said one or more objects of the information from the First Computer System 105 to the Second Computer System 106.

It will be appreciated that the term “Internet” refers to a network of networks. Such networks may use a variety of protocols for exchange of information, such as TCP/IP, ATM, SNA, SDI, etc. The physical connections of the Internet and the protocols and communication procedures of the Internet are well known to those in the art. It will be also appreciated that the said systems may be implemented in an intranet within an organization.

In some embodiments, the First Computer System 105 and the Second Computer System 106 can be made in the form of (can be represented by) the portable multi-function device, personal computer, server, virtual machine, cellphone, laptop, tablet PC, smartphone, etc.

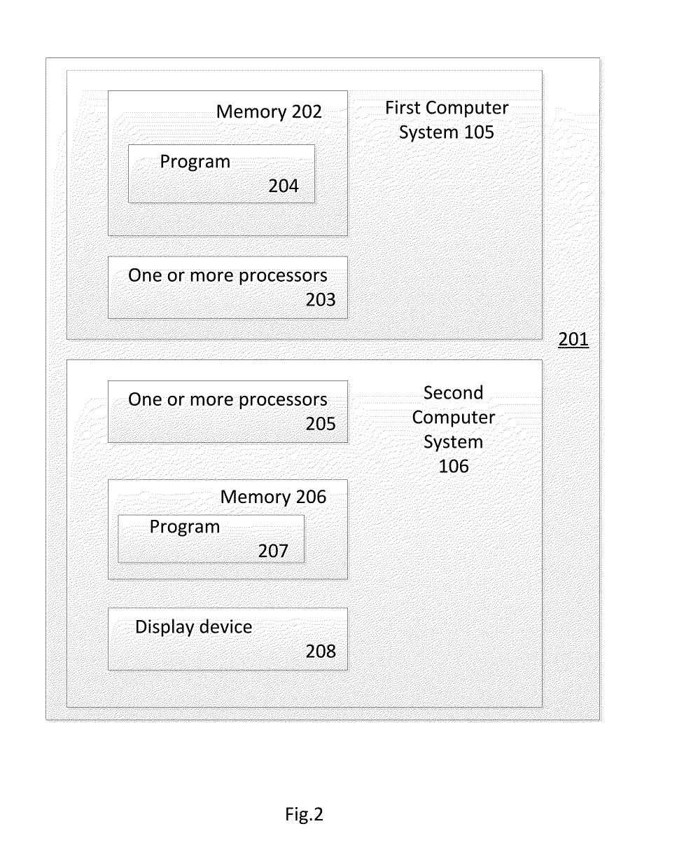

FIG. 2 illustrates a system for communication 201 in accordance with some embodiments. The system for communication 201 comprises two computer systems: the First Computer System 105 and the Second Computer System 106. In this embodiment, as well as others described below, the First Computer System 105 is used to get one or more objects of the information and transfer it to the Second Computer System 106. In one embodiment, the First Computer System 105 comprises one or more processors 203, a memory 202 and a program 204, stored in the memory 202 and executed by one or more processors 203. The program 204 includes instructions for launching the program 204 on the First Computer System 105, collecting one or more objects of the information and sending the said one or more objects of the information to the Second Computer System 106. Objects of the information might be collected from various sources, including, but not limited to, the First Computer System 105, the Second Computer System 106, a computer system of the third party, a cellphone of the user of the First Computer System 105, a cellphone of the user of the Second Computer System 106, user input data, logs of the program 204 usage.

The Second Computer System 106 comprises one or more processors 205, a memory 206, a display device 208 and a program 207, stored in the memory 206 and executed by the said one or more processors 205. The program 207 includes instructions for receiving one or more objects of the information from the First Computer System 105 and showing the said one or more objects of the information on the display device 208.

In some embodiments, the program 207 may comprise more than one program. In some embodiments, the memory 206 may additionally comprise a database to store one or more parts of the program 207. In another embodiment, the program 207 is split between the Second Computer System 106 and a third party storage device.

In some embodiments, types of presentation of the said one or more objects of the information on the display device 208 of the Second Computer System 106 may include, but are not limited to, the Graphical User Interface (GUI), a text message, an image, a video clip, a html-page, a table, an ordered list, an unordered list, SMS message, EMS message, e-mail message.

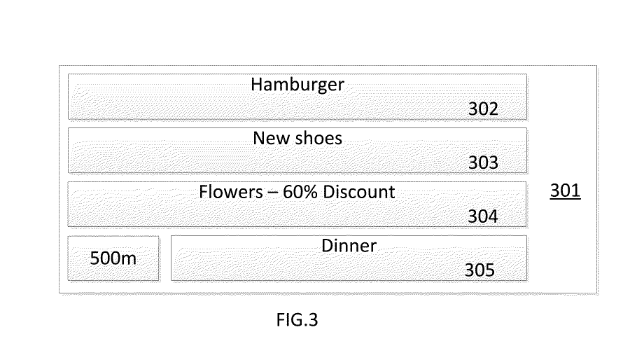

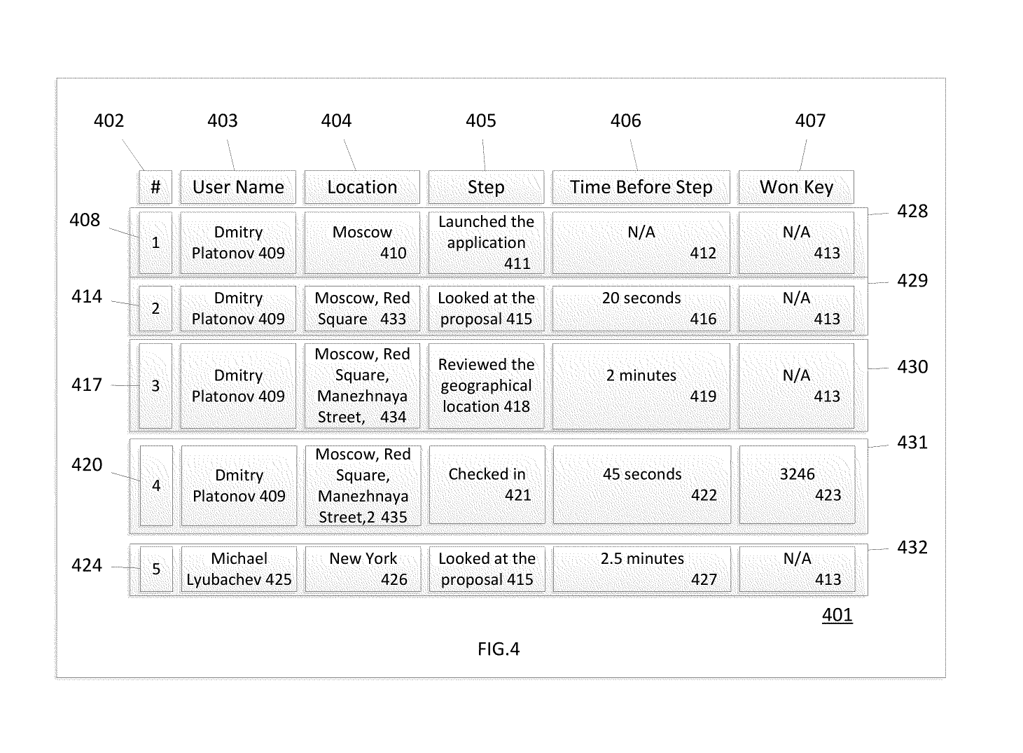

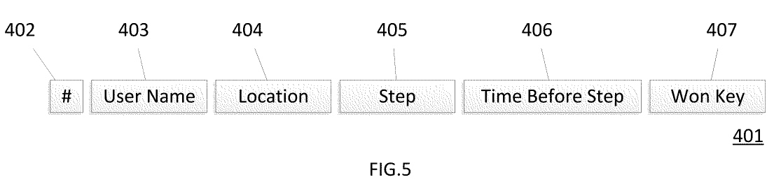

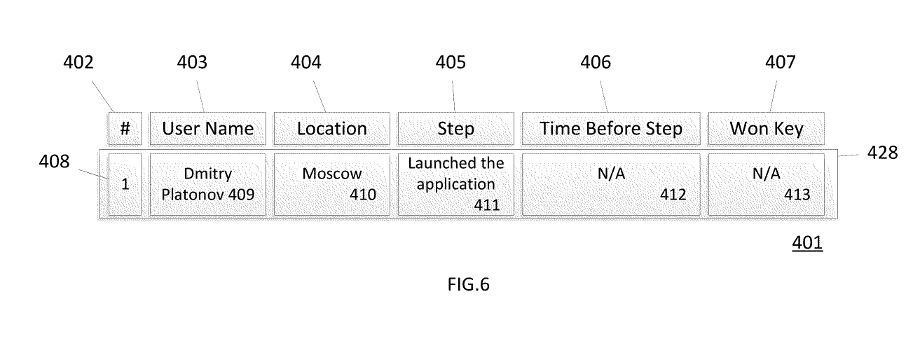

FIG. 3, FIG. 4, FIG. 5, and FIG. 6 illustrate an exemplary embodiment of the present invention. After the program 204 has launched 101 on the First Computer System 105, the First Computer System 105 will retrieve objects of the information from the First Computer System 105, such as: user name, location of the First Computer System 105, description of the action. In this exemplary embodiment, the said objects of the information are made in the form of text message. Accordingly, object of the information “user name” equals the following text (without quotes): “Dmitry Platonov;” object of the information “location” equals the following text (without quotes): “Moscow;” object of the information “description of the action” equals the following text (without quotes): “Launched the application.” After objects of the information are collected, the First Computer System 105 sends the said text data to the Second Computer System 106. Upon receiving the said text data, the Second Computer System 106 shows the said text data on the display device 208. The said text data is shown on the display device 208 by means of user interface. An example of the above-mentioned user interface is shown in FIG. 4.

FIG. 5 illustrates an example of the graphical user interface according to the exemplary embodiment described above. According to the embodiment, the said text data is displayed in the table 401. The said table contains columns “#” 402, “User name” 403, “Location” 404, “Step” 405, “Time Before Step” 406, “Won key” 407. In this particular exemplary embodiment, column “#” 402 contains the number of the row; column “User Name” 403 contains text data of the object of the information “user name;” column “Location” 404 contains text data of the object of the information “location;” column “Step” 405 contains text data of the object of the information “description of the action;” column “Time Before Step” 406 contains text data of the object of the information “time before step;” column “Won Key” 407 contains text data of the object of the information “won key.” Accordingly, upon receiving on the Second Computer System 106 the said objects of the information from the First Computer System 105, the Second Computer System 106 adds a new row 428 to the table 401. The row 428 consists of the following cells:
Cell 408 contains number “1,” which indicates that row 428 is the first row in the table 401. Cell 408 belongs to the column “#” 402;
Cell 409 contains object of the information “user name,” which, in this exemplary embodiment, is represented by text “Dmitry Platonov.” Cell 409 belongs to the column “User Name” 403.
Cell 410 contains object of the information “Location,” which in this exemplary embodiment is represented by text “Moscow.” Cell 410 belongs to the column “Location” 404.
Cell 411 contains object of the information “Step,” which in this exemplary embodiment is represented by text “Launched the application.” Cell 411 belongs to the column “Step” 405.
Cell 412 contains object of the information “Time before step,” which in this exemplary embodiment is represented by text “N\A,” because the Second Computer System 106 didn't receive the object of the information “time before step.” Cell 412 belongs to the column “Time Before Step” 406.
Cell 413 contains object of the information “Won Key,” which in this exemplary embodiment is represented by text “NSA,” because the Second Computer System 106 didn't receive object of the information “won key.” Cell 413 belongs to the column “Won Key” 407.

User of the Second Computer System 106 will see, on the display device 208, a user interface, which is shown in FIG. 6.

FIG. 3 illustrates a user interface, according to the present exemplary embodiment, of the First Computer System 105. In this exemplary embodiment, the First Computer System 105 additionally contains a display device. The said user interface appears on the display device of the First Computer System 105 after the Program 204 finishes loading. By the time that the Program 204 finishes loading, the First Computer System 105 will have already sent four objects of the information to the Second Computer System 106. These four objects of the information are described above.

In this exemplary embodiment, each action of the user of the First Computer System 105 will force the Program 204 to collect objects of the information from the First Computer System. For example, as was already described above, object of the information “Step” for action “Launching the Program 204” is equal to “Launched the application.” After the program 204 is launched, the Program 204 starts to count time. When the First Computer System 105 receives a command from the user of the First Computer System 105, the Program 204 assigns the said counted time to the object of the information “Time before step.”

Upon clicking on one of the buttons 302, 303, 304, 305 of the user interface, which is shown on the display device of the First Computer System 105, the object of the information “Step” will be changed from “Launched the application” to “Looked at the proposal.” The program additionally assigns counted time to the object of the information “Time before step” and resets the timer. In this exemplary embodiment, it is assumed that:
the user of the First Computer System 105 and First Computer System 105 is located in the Moscow, Red Square, Manezhnaya Street, 2;
the user of the First Computer System 105 launches the program 204;
the user of the First Computer System 105 spends 20 seconds after the Program 204 was launched and before clicking on the button 302;
when the First Computer System 105 reaches idle status, it begins to specify its geographical location;
after launching the program 204 and due to the limited amount of time to get detailed information about the location, the First Computer System 105 assigns to the object of the information “location” a name of the city, where the First Computer System 105 is located. In other embodiments, the First Computer System might be able to get all information about geographical location and assign it to the object of the information “location;”
during the time that the user of the First Computer System 105 spends after launching the program 204 and before clicking the button 302, the First Computer System 105 specifies the geographical location of the First Computer System 105 and assigns information about the geographical location of the First Computer System 105, which is made in the form of text data: “Moscow, Red Square” to the object of the information “location;”
the proposal with the title “Hamburger,” which will be opened after the user of the First Computer System 105 clicks on the button 302, was posted by the user of the Second Computer System 106.

After the user of the First Computer System 105 clicks on the button 302, the First Computer System 105 gets the following objects of the information:
object of the information “user name” equals the following text (without quotes): “Dmitry Platonov;” in this particular exemplary embodiment, object of the information “user name” represents the first and last name of the user of the First Computer System 105;
object of the information “location” equals the following text (without quotes): “Moscow, Red Square;”
object of the information “description of the action” equals the following text (without quotes): “Looked at the proposal;”
object of the information “time before step” equals the following text (without quotes): “20 seconds.” It should be obvious to one skilled in the art that the text “20 seconds” can be easily converted to the number “20” and vice versa.

After objects of the information are collected, the First Computer System 105 sends the said text data to the Second Computer System 106. Upon receiving, on the Second Computer System 106, the said objects of the information from the First Computer System 105, the Second Computer System 106 adds a new row 429 to the table 401. The row 429 consists of the following cells:
the cell 414 contains the number “2,” which indicates that row 429 is the second row in the table 401. The cell 414 belongs to the column “#” 402;
the cell 409 contains object of the information “user name,” which, in this exemplary embodiment, is represented by text “Dmitry Platonov.” The cell 409 belongs to the column “User Name” 403.
the cell 433 contains object of the information “Location,” which in this exemplary embodiment is represented by text “Moscow, Red Square.” In this particular exemplary embodiment, the First Computer System 105 was able to get, in 20 seconds, only information about the city and square where the First Computer System 105 is located. The cell 428 belongs to the column “Location” 404.
the cell 415 contains object of the information “Step,” which in this exemplary embodiment is represented by text “Looked at the proposal.” The cell 415 belongs to the column “Step” 405.
the cell 412 contains object of the information “Time before step,” which in this exemplary embodiment is represented by text “N\A,” because the Second Computer System 106 didn't receive object of the information “time before step.” The cell 412 belongs to the column “Time Before Step” 406.
the cell 413 contains object of the information “Won Key,” which in this exemplary embodiment is represented by text “N\A,” because the Second Computer System 106 didn't receive object of the information “won key.” The cell 413 belongs to the column “Won Key” 407.

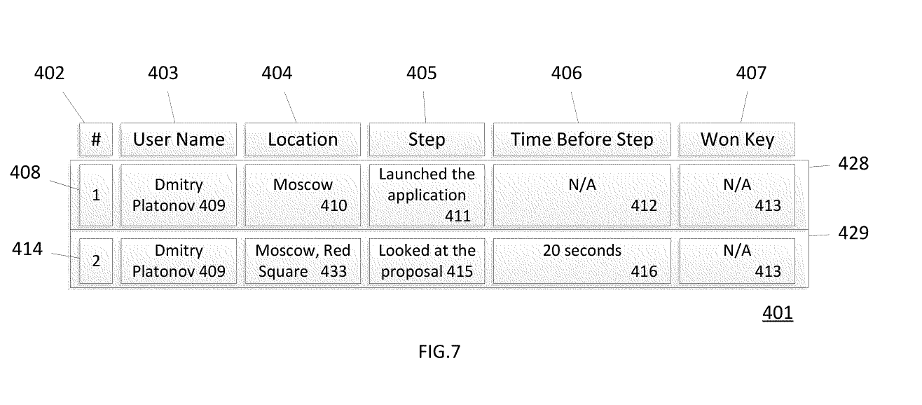

User of the Second Computer System 106 will see, on the display device 208, a user interface, which is shown in FIG. 7.

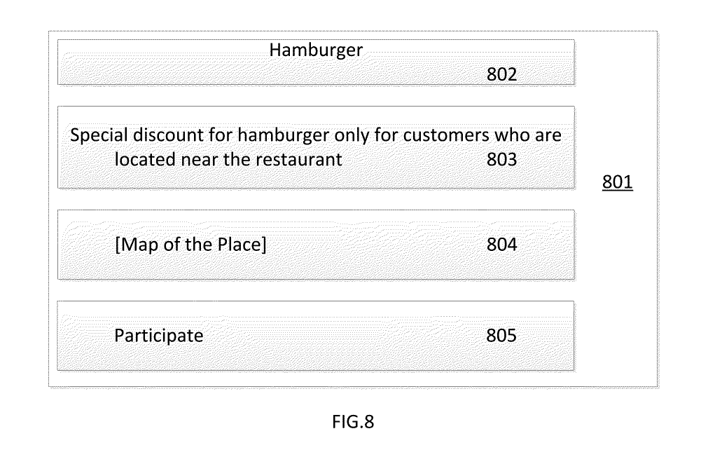

After the First Computer System 105 successfully sends the said objects of the information to the Second Computer System 106, the First Computer System 105 shows, on the display device of the First Computer System 105, the description of the proposal titled “Hamburger” on the button 302. FIG. 8 illustrates the main blocks of the description of the proposal 801 titled “Hamburger,” that will appear on the display device of the First Computer System 105. The description of the proposal, in this exemplary embodiment, consists of the four blocks. It should be obvious to one skilled in the art that the description of the proposal might contain one or more blocks of text and/or sound data and/or video data. The description of the proposal in this exemplary embodiment comprises:
the title of the proposal 802;
the main point of the proposal 803;
the geographical location of the place 804, where the user of the First Computer System 105 or Second Computer System 106 might redeem the proposal 801;
participate button 805.

Upon clicking on the button 805, the First Computer System 105 collects the following objects of the information:
object of the information “User Name” equals the following text (without quotes): “Dmitry Platonov;”
object of the information “Location” equals the following text (without quotes): “Moscow, Red Square, Manezhnaya Street,”
object of the information “Description of the Action” equals the following text (without quotes): “Reviewed the geographical location,”
object of the information “Time Before Step” equals the following text (without quotes): “2 minutes.” After object of the information “time before step” was collected by the First Computer System 105, the First Computer System 105 reset the timer, which indicates the amount of time after the user of the First Computer System 105 clicks on the button 302 and before the user of the First Computer System 105 clicks on the button 805.

After objects of the information are collected, the First Computer System 105 sends the said text data to the Second Computer System 106. Upon receiving, on the Second Computer System 106, the said objects of the information from the First Computer System 105, the Second Computer System 106 adds a new row 430 to the table 401. The row 430 consists of the following cells:
the cell 417 contains the number “3,” which indicates that row 430 is the third row in the table 401. The cell 417 belongs to the column “#” 402;
the cell 409 contains object of the information “user name,” which, in this exemplary embodiment, is represented by text “Dmitry Platonov.” The cell 409 belongs to the column “User name” 403.
the cell 434 contains object of the information “Location,” which in this exemplary embodiment is represented by text “Moscow, Red Square, Manezhnaya Street.” In this particular exemplary embodiment, the First Computer System 105 was be able to get, in 2 minutes, only information about the city, square and street where the First Computer System 105 is located. The cell 434 belongs to the column “Location” 404.
the cell 418 contains object of the information “Step,” which in this exemplary embodiment is represented by text “Reviewed the geographical location.” The cell 418 belongs to the column “Step” 405.
the cell 419 contains object of the information “Time before step,” which in this exemplary embodiment is represented by text “2 minutes.” The cell 419 belongs to the column “Time Before Step” 406.
the cell 413 contains object of the information “Won Key,” which in this exemplary embodiment is represented by text “N\A,” because the Second Computer System 106 didn't receive object of the information “won key.” The cell 413 belongs to the column “Won Key” 407.

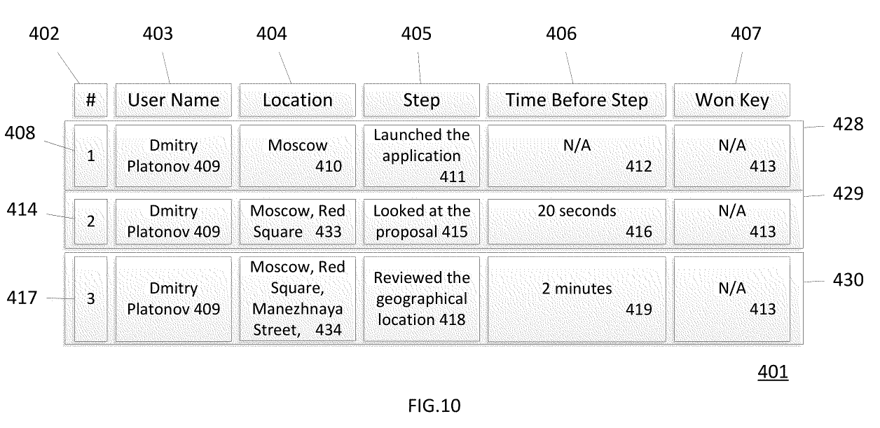

The user of the Second Computer System 106 will see, on the display device 208, a user interface, which is shown in FIG. 10.

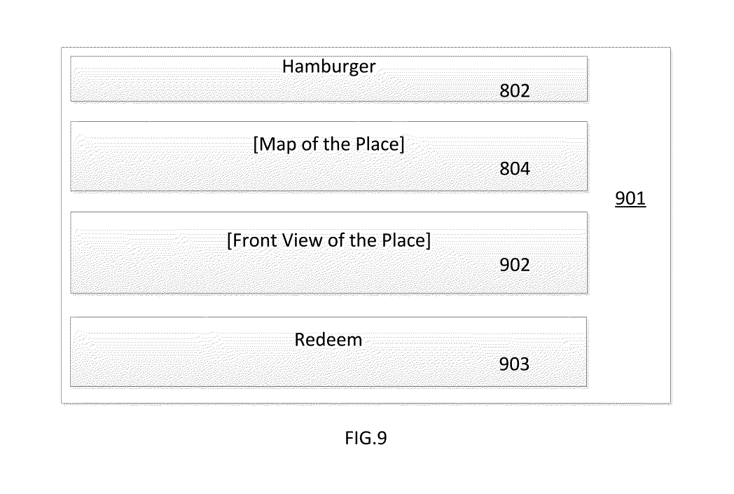

After all the said objects of the information were sent, the First Computer System 105 shows, on the display device of the First Computer System 105, the user interface 901, which is shown in FIG. 9. The user interface 901 consists of the following blocks of data:
the title of the proposal 802;
the geographical location of the place 804 where the user of the First Computer System 105 or Second Computer System 106 might redeem the proposal 801;
the front view of the place 902, which, in this exemplary embodiment, is represented by the image of the front view of the building or place where the customer might redeem the proposal 801.
the redeem button 903.

In this exemplary embodiment, the map of the place 804 is created by Google® Maps® application. In other embodiments, the creator of the proposal 801 might include an image of the geographical location of the proposal and/or video record, showing the path to the place where customers might redeem the proposal 801 and/or use another third party component. In some embodiments, the front view of the place 902 might be represented in the form of a drawing, audio and/or video record.

When the user of the First Computer System 105 clicks on the “Redeem” button 903, the First Computer System performs the following operations:
First of all, the First Computer System 105 collects the following objects of the information:
   object of the information “user name” equals the following text (without quotes): “Dmitry Platonov;”
   object of the information “location” equals the following text (without quotes): “Moscow, Red Square, Manezhnaya street, 2;”
   object of the information “description of the action” equals the following text (without quotes): “Checked in;”
   object of the information “time before step” equals the following text (without quotes): “45 seconds.” It is assumed that the user of the First Computer System 105 clicks on the “Redeem” button 903 in 45 seconds after clicking on the “Participate” button 805. After object of the information “time before step” is collected by the First Computer System 105, the First Computer System 105 resets the timer, which indicates the amount of time after the user of the First Computer System 105 clicks on the button 302 and before the user of the First Computer System 105 clicks on the button 805.
   object of the information “won key” equals the following text (without quotes): “3246.”
Second, the First Computer System 105 sends the above-mentioned objects of the information to the Second Computer System 106.

Upon receiving the above-mentioned objects of the information, the Second Computer System 106 adds a new row 431 to the table 401. The row 431 consists of the following cells:
the cell 420 contains the number “4,” which indicates that the row 431 is the fourth row in the table 401. The cell 420 belongs to the column “#” 402;
the cell 409 contains object of the information “user name,” which, in this exemplary embodiment, is represented by text “Dmitry Platonov.” The cell 409 belongs to the column “User name” 403.
the cell 435 contains object of the information “Location,” which in this exemplary embodiment is represented by text “Moscow, Red Square, Manezhnaya Street 2.” In this particular exemplary embodiment, the First Computer System 105 was able to get, in 45 seconds, all information about geographical location of the First Computer System 105. The cell 435 belongs to the column “Location” 404.
the cell 421 contains object of the information “Step,” which in this exemplary embodiment is represented by text “Checked in.” Cell 421 belongs to the column “Step” 405.
the cell 422 contains object of the information “Time before step,” which in this exemplary embodiment is represented by text “45 seconds.” The cell 422 belongs to the column “Time Before Step” 406.
the cell 423 contains object of the information “Won Key,” which in this exemplary embodiment is represented by text “3246.” The cell 413 belongs to the column “Won Key” 407.

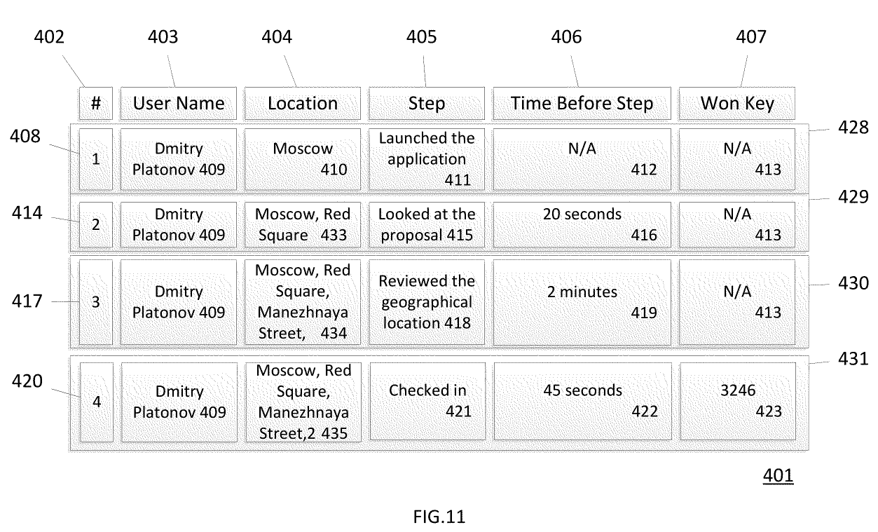

The user of the Second Computer System 106 will see, on the display device 208, a user interface, which is shown in FIG. 11.

In another embodiment, the present invention comprises one more computer system “Third Computer System,” which is identical to the First Computer System 105. The owner of the Third Computer System is Michael Lyubachev. While interacting with the user interfaces shown in FIGS. 3, 8, and 9, the Third Computer System collects objects of the information from the Third Computer System and sends it to the Second Computer System 106. For example, after the user of the Third Computer System clicks on the button 302, the Third Computer System collects the following objects of the information:
object of the information “user name” equals the following text (without quotes): “Michael Lyubachev;”
object of the information “location” equals the following text (without quotes): “New York;”
object of the information “description of the action” equals the following text (without quotes): “Looked at the proposal;”
object of the information “time before step” equals the following text (without quotes): “2.5 minutes.” It is assumed that the user of the Third Computer System clicks on the button 302 in 2.5 minutes after launching the program 204. After object of the information “time before step” was collected by the Third Computer System, the Third Computer System reset the timer.

Upon receiving the above-mentioned objects of the information from the Third Computer System, the Second Computer System 106 adds a new row 432 to the table 401. The row 432 consists of the following cells:
the cell 424 contains the number “5,” which indicates that row 432 is the fifth row in the table 401. The cell 424 belongs to the column “#” 402;
the cell 425 contains object of the information “user name,” which, in this exemplary embodiment, is represented by text “Michael Lyubachev.” The cell 425 belongs to the column “User Name” 403.
the cell 426 contains object of the information “Location,” which in this exemplary embodiment is represented by text “New York.” In this particular exemplary embodiment, the First Computer System 105 was be able to get, in 2.5 minutes, only part of the information about geographical location of the Third Computer System. The cell 426 belongs to the column “Location” 404.
the cell 415 contains object of the information “Step,” which in this exemplary embodiment is represented by text “Looked at the proposal.” The cell 415 belongs to the column “Step” 405.
the cell 427 contains object of the information “Time before step,” which in this exemplary embodiment is represented by text “2.5 minutes.” The cell 427 belongs to the column “Time Before Step” 406.
the cell 413 contains object of the information “Won Key,” which in this exemplary embodiment is represented by text “N\A,” because the Second Computer System 106 didn't receive object of the information “won key” from the Third Computer System. The cell 413 belongs to the column “Won Key” 407.

User of the Second Computer System 106 will see, on the display device 208, a user interface, which is shown in FIG. 4.

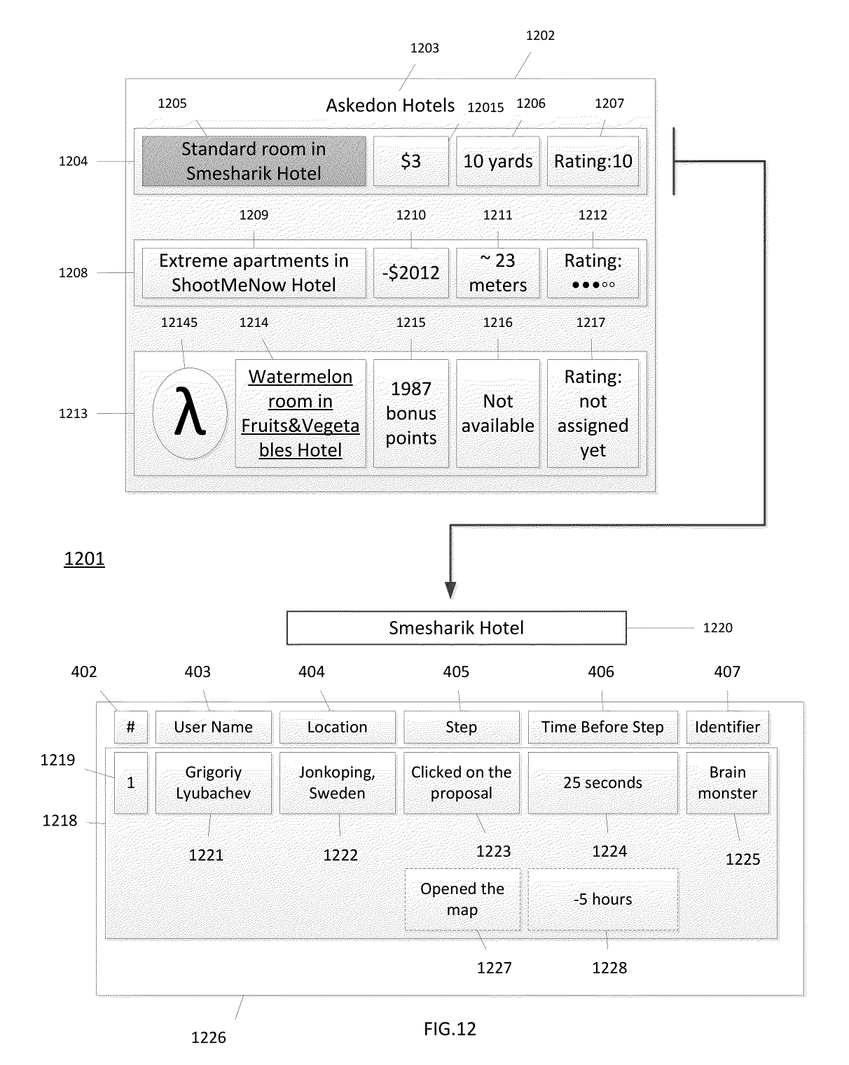

In some embodiments, the present invention can be used in hotels or in other companies that offer room rent services. FIG. 12 shows how the present invention can be implemented in hotels or in other companies that offer room rent services. The one or more programs, located in the first computer system, for example in the portable multifunction device (iPhone, Android-based smartphone, Windows Phone-based smartphone or other) comprise the graphical user interface 1202. The graphical user interface 1202 comprises the title “Askedon Hotels” 1203 and three rows 1204, 1208 and 1213 with cells. The first row 1204 comprises the following cells:
the cell 1205 contains information about the type of rooms and the hotels in which these kinds of rooms are available. In this exemplary embodiment “Standard room” is a room type and “Smesharik hotel” is the brand name of the hotel. In some embodiments, the row 1204 might comprise an image and/or sound and/or video records about the promo-campaign. Background gray color shows that the user of the first computer system has clicked on the cell 1205. Below will be described how the present invention works after the action of clicking on the cell 1205. In some embodiments, other cells, for example, 12015, 1206, 1207, in the row 1204 can be clickable, i.e., contain a link which makes the present invention work in the same way as it was when the user clicked on the cell 1205;
the cell 12015 contains information about price of the offer and/or the discount rate and/or the coupon price. In some embodiments, the information about the price can be made in the form of a text message, sound record, video record or a combination thereof;
the cell 1206 shows the distance between the current geographical location and the geographical location of the place where the company, which offers goods and/or services described in the promo-campaign, is located.
the cell 1207 shows the rating of the company that offers goods and/or services described in the promo-campaign. In this exemplary embodiment, the displayed rating is an average rating from customers who have already purchased goods and/or services from the company that offered goods and/or services in the promo-campaign displayed in the row 1205. In some embodiments, the rating can be calculated automatically by the computer system using one or combination of the following factors: time before purchase, number of messages between one or more company representatives, feedback of the user, the rating submitted by the customers, the rating submitted by the users of the first or second computer systems, the rating submitted by the potential customers, the number of messages in one or more social networks, the rating downloaded from third party resources, the number of goods and/or services purchased, the price of the goods and/or services, the number of the groups of customers, the geographical location of the place, the computer system configuration, the network speed, the difference between potential customers and existing customers, etc. It should be understood that the present invention should not be limited to the factors described above.

The row 1208 comprises the following cells:
the cell 1209 shows the title of the proposal. In this exemplary embodiment, the title of the proposal comprises the room type “Extreme Apartments” and brand name of the hotel “ShootMeNow Hotel;”
the cell 1210 shows the price of the apartments from the proposal. In this exemplary embodiment, the price is negative, which means that the hotel which is offering the proposal with the title 1209 will pay the guest for the room rent services;
the cell 1211 shows the approximate distance to the location of the office of the company which is offering the proposal with the title from the cell 1209. The distance can be “accurate” and “approximate.” It should be understood that both “accurate” and “approximate” distances are calculated with a percentage of inaccuracy;
the cell 1212 shows the rating of the room which is the subject for rent in the proposal displayed in the row 1208. In this exemplary embodiment, the rating is three of a maximum of five points. For a rating of four, the cell 1212 will contain four black dots and one white dot. In some embodiments of the present invention, the rating can be downloaded or provided by one or more third parties. If the one or more third parties have another method of information representation, then the first computer system, using specific algorithms, converts the one or more third party rating to the native rating for the one or more programs that are stored in the first computer system.

The row 1213 comprises the following cells:
the cell 12145 comprises the logo of the “Fruits&Vegetables” hotel. As shown in this exemplary embodiment, the proposal from the hotel can be shown with or without the logo or trademark;
the cell 1214 comprises the room type and the title of the hotel. In this exemplary embodiment, the room type and the title of the hotel comprises a link to another graphical user interface within the one or more programs stored in the first computer system, or to the web-page (in this case, at the moment of filing this patent application, typically the smartphone operation system closes the one or more programs and opens the browser);
the cell 1215 comprises the price of the room rent services. In this exemplary embodiment, the price is shown in the bonus point currency. In the past several years, loyalty programs have become very popular. For example, banks create a plastic card with the brand name of one of the airlines. On paying with such a plastic card, the customer gets so called “bonus miles,” which later can be used to purchase tickets. In this exemplary embodiment, the payment for the room rent services can be made via bonus points or virtual currency. Such virtual currency can be obtained in the various ways which are in existence at the moment of the patent application filing or which will be created or invented in the future. For example, virtual currency can be obtained from the third party shop where the customer purchased one or more goods, or from the provider of the one or more programs which are stored in the memory of the first computer system;
the cell 1216 comprises information about the distance to the point of sales where the customer can purchase the goods and/or services that are described in the promo-campaign. In this exemplary embodiment, the first computer system was unable to get information about the current geographical location and, therefore, unable to calculate the distance between the point of sale and the potential customer. In some embodiments of the present invention, the one or more programs can store information about previous locations of the first computer system and, in case of error in obtaining the geographical location, put the information about one or more previous locations to the algorithm that calculates the distance between the point of sale and the first computer system location. The result distance will be shown in the cell 1216;
the cell 1217 comprises information about the rating of the company or specific point of sale. In this exemplary embodiment, the rating is obtained from users' feedback. “Not assigned” status of rating indicates that no users have provided feedback about the promo-campaign shown in the row 1213. In some embodiments of the present invention, the rating comprises one or combination of a text message, image, photo, video record, sound record.

The background color of the cell 1205 is gray, which indicates that one or more users of the first computer system clicked on the cell 1205. After one or more users of the first computer system clicked on the cell 1205, the first computer system collects the following objects of the information:
the full name of the user. In this exemplary embodiment, the full name of the user is “Grigoriy Lyubachev.” In some embodiments of the present invention, the full name comprises one or combination of the following elements: text, image, photo, personal information, private information, messages associated with the user, video record, sound record, one or more links to the social network profiles;
current geographical location of the first computer system. In this exemplary embodiment, the first computer system was unable to get all information about the geographical location. As a result, the object of the information comprises the city and the country in which the first computer system is located. In some embodiments of the present invention, the first computer system will not comprise means for determining a geographical location. In this case, the first computer system will be unable to get the current geographical location and collect the associated one or more objects of the information;
description of the action that was performed by one or more users of the first computer system. In some embodiments of the present invention, the “idle” status of the computer, when the one or more users of the first computer system perform no actions can still be recognized as an action, for example, with description: “idle,” “no action,” “no interaction;”
the amount of time that one or more users spent before the action. In some embodiments of the present invention, the first computer system comprises event triggers, which can work in the background and not be visible for the one or more users of the first computer system, or the first computer system can display the timer and/or list of the event triggers to the user or both. In some embodiments of the present invention, the time can be calculated and shown in one or in a combination of the following: seconds, hours, milliseconds, days, weeks, months, years, centuries, bonus points, money, images, bonus goods and/or services;
the one or more identifiers that can be used to identify one or more users of the first computer system and/or the first computer system on the second computer system or intermediate computer system. In some embodiments, the identifier comprises one or a combination of the following elements: text, number, symbol, mathematical formulae, image, sound record, video record.

After all objects of the information are collected, the first computer system sends part or all objects of the information to the second computer system which is located, in this exemplary embodiment, in the hotel. In some embodiments of the present invention, the first computer system sends part or all collected objects of the information, first to the intermediate computer system, and then the intermediate computer system sends part or all received objects of the information to the second computer system. After receiving part or all objects of the information collected at the first computer system, the second computer system shows part or all received objects of the information to the one or more users of the second computer system. In this exemplary embodiment, the second computer system shows on the display device a table 1226, which comprises all objects of the information collected at the first computer system. The second computer system creates new row 1218 for the received objects of information. The row 1218 comprises the following rows:
the row 1219, which comprises the number of the row in the table 1226. In this particular exemplary embodiment, the number is “1” because the row 1218 is the first row in the table 1226. In some embodiments of the present invention, the cell 1219 and/or the column, which indicates the number of the row in the table 1226, can be deleted or hidden;
the cell 1221, which comprises the first and last name of the user of the first computer system. In some embodiments, the cell 1221 can comprise identification information, for example, sex, age, preferred type of shopping, the average amount of the money that the user spent in the shops, history of orders, wish list. In some embodiments the cell 1221 can comprise information about more than one person. In case of error in information about user identification, the cell can comprise the error description and/or notification;
the cell 1222, which comprises the information about geographical location of the first computer system. In this exemplary embodiment, the first computer system was unable to identify the exact geographical location. Therefore, the cell 1222 comprises only information about the country and city where the first computer system is located. In some embodiments of the present invention, the cell 1222 can additionally comprise a button or a link to the map, with a pointer, which indicates the geographical location of the first computer system. In some embodiments, the second computer system obtains information about the geographical location of the one or more computer systems, which sent objects of the information to the second computer system and put the pointers of the computer systems location on the map. As a result, the one or more users of the second computer system will see the location on the map of all the computer systems that sent one or more objects of the information to the second computer system;
the cell 1223, which comprises information about action performed by the first computer system or the one or more users of the first computer system. In this exemplary embodiment, the user of the first computer system clicked on the cell 1205. That is why the employee of the “Smesharik” hotel
   the owner of the promo-campaign indicated in the cell 1205
   sees that the user “Grigoriy Lyubachev” performed the action “Clicked on the proposal.” In some embodiments, the object of the information which describes the performed action can comprise one or combination of the following elements: text, image, sound record, video record, symbol, character;
the cell 1224, which comprises the amount of time that the computer system works after the previous action. In this exemplary embodiment, the timer was set to zero after the first computer system finished loading of the software application. In some embodiments, the one or more users of the second computer system have an ability to reset the timer on the first computer system. Additionally, in some embodiments, the second computer system also has a timer which collects information about the activity of the one or more users of the second computer system. The object of the information which indicates the amount of time between the actions can comprise one or a combination of the following elements: text, image, sound record, video record, symbol, character;
the cell 1225, which comprises the identifier assigned to this particular one or more users. In this exemplary embodiment, the identifier “Brain Monster” was assigned automatically by the second computer system. In some embodiments, the cell 1225 can comprise a button or a link, which can be used for identifier editing or one or more text fields, which the one or more users of the second computer system can use to edit the one or more identifiers. The identifier can comprise one or a combination of the following elements: text, image, sound record, video record, symbol, character. In some embodiments, the identifier can be assigned manually by the one or more users of the second computer system or “semi-automatically,” which means that the second computer system will send one or more requests to the one or more users of the second computer system to assign one or more identifiers.

When one or more users of the first computer system continue the interaction with the promo-campaign and the next action occurs, the first computer system immediately collects one or more objects of the information about the new action and sends it to the second computer system. In this exemplary embodiment, the second computer system analyzes the received one or more objects of the information and adds only changed objects of the information, in comparison with the first portion of the objects of the information, to the first row 1218. The cells 1227 and 1228 correspond to the new action that occurred on the first computer system. Other objects of the information, such as user name, geographical location and identifier remain the same. In some embodiments, the second computer system adds a new row for each portion of objects of the information, which comprises one or more objects of the information. In this case, after new action has occurred on the first computer system, the second computer system adds a new row, with the cells 1221, 1222, 1227, 1228, 1225. In some embodiments, the first computer system also collects information about one or more users of the first computer system communication. In these embodiments, the first computer system also sends one or more objects of the information about one or more users of the first computer system communication to the second computer system. In some embodiments, the first computer system additionally collects information about the first computer system configuration. In these embodiments, the first computer system sends one or more objects of the information about the first computer system configuration to the second computer system. In some embodiments and in case the computer system was unable to send one or more objects of the information, the first computer system stores the one or more objects of the information in the device for storing data. When the first computer system has an ability to send objects of the information to the second computer system, it sends it immediately or after ‘confirmation from one or more users of the first computer system. In some embodiments, the representation of objects of the information and/or associated elements can be made in a form other than that of a table.

Disclaimer. The example companies, organizations, products, people, places, and events depicted herein are fictitious. No association with any real company, organization, product, person, places, or events is intended or should be inferred.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer implemented method of interaction between first user working at the first computer system and second user, working at the second computer system, said first and second computer systems can intercommunicate with each other by means of communication modules, said method comprising the following steps:
a) obtaining information, at a first computer system, about first user interaction with one or more computer programs and with corresponding data, stored at the first computer system;
b) sending to the second computer system, all or part of the information about the first user interaction with one or more programs and corresponding data;
c) receiving, all or part of the information about the first user interaction with one or more programs and corresponding data;
d) analyzing all or part of the received information;
e) choosing one of the preliminarily created scenarios or politics of further promotion or development of products or services on the base of performed analysis.

2. The method of claim 1, wherein the step (a) comprises obtaining one of the following or combination of:
the first computer system identifier,
information about user of the first computer system,
time,
date,
cell-phone number,
geographical location of the first computer system,
image,
sound record,
text data,
video record,
third party identifiers,
SMS message,
MMS message.

3. A system for communication comprising:
a) a first computer system,
b) a second computer system,
wherein the first computer system further comprising:
one or more processors;
a device for storing data;
a communication module;
one or more programs, created or distributed by a user of the second computer system,
wherein one or more programs of the first computer system are stored in the device for storing data of the first computer system and configured to be executed by one or more processors of the first computer system, one or more programs of the first computer system containing instructions for:
obtaining information about first user interaction with one or more programs and with corresponding data;
sending, by means of a communication module of the first computer system, all or part of the information about first user interaction with one or more programs of the first computer system and with corresponding data to the second computer system,
wherein the second computer system comprising:
one or more processors;
a device for storing data;
a communication module;
one or more programs,
wherein the one or more programs of the second computer system are stored in the device for storing data of the second computer system and configured to be executed by the one or more processors of the second computer system, the one or more programs of the second computer system containing instructions for:
receiving, by means of a communication module of the second computer system, all or part of the information about first user interaction with one or more programs of the first computer system and with corresponding data;
analyzing all or part of the received information.

4. The system of claim 3, wherein the first computer system comprises one or combination of the following:
a personal computer,
a camera,
a cell phone,
a laptop,
a tablet PC,
a smart-phone,
a portable multi-function device,
a virtual machine.

5. The system of claim 3, wherein the second computer system comprises one or combination of the following:
a personal computer,
a camera,
a cell phone,
a laptop,
a tablet PC,
a smart-phone,
a portable multi-function device,
a virtual machine.

6. The system of claim 3, wherein a device for storing data is a memory of the computer system.

7. The system of claim 3, wherein a device for storing data is a database located on the computer system.

8. The system of claim 3, wherein all or a part of the first computer system is located in the cloud environment.

9. The system of claim 3, wherein all or a part of the second computer system is located in the cloud environment.

10. The system of claim 3, wherein the device for storing data of the first computer system is located in the cloud environment.

11. The system of claim 3, wherein the device for storing data of the second computer system is located in the cloud environment.

12. The system of claim 3, wherein the following parts of the second computer system are located in the cloud environment: one or more processors, the device for storing data, the analysis module.

13. The system of claim 3, wherein the first computer system additionally comprise an output device.

14. A system for communication comprising:
a) a first computer system group,
b) a second computer system,
wherein the first computer system group comprising two or more computer systems;
wherein each computer system from the first computer system group comprises at least the following elements:
one or more processors #1;
one or more devices for storing data #1;
one or more communication modules #1;
one or more programs #1, which are created or distributed by a user of the second computer system;
wherein the one or more programs #1 are stored in one or more devices for storing data #1 and configured to be executed by the one or more processors #1, the one or more programs #1 containing instructions for:
establishing a network connection, by means of the one or more communication modules #1 to one or more computer systems from the first group;
obtaining information about one or more users of the one or more computer systems from the first computer system group interaction with one or more programs #1 and with corresponding data;
sending, from one or more computer systems from the first group and by means of the one or more communication modules #1 all or part of the information about the users of the one or more computer systems from the first computer system group interaction with one or more programs #1, corresponding data and information about first computer group connections to the second computer system group;
wherein the second computer system comprises at least the following elements:
one or more processors #2;
one or more devices for storing data #2;
one or more communication modules #2;
one or more programs #2;
wherein the one or more programs #2 are stored in the one or more devices for storing data #2 and configured to be executed by the one or more processors #2, the one or more programs #2 containing instructions for:
receiving, by means of the one or more communication modules #2 of the second computer system, all or part of the information about one or more users of the one or more computer systems from the first computer system group interaction with one or more programs #1 of the first computer system group, corresponding data and information about first computer group connections;
analyzing all or part of the received information.

15. The system of claim 14, wherein one or more computer systems from the first computer system group comprises one or combination of the following:
a personal computer,
a camera,
a cell phone,
a laptop,
a tablet PC,
a smart-phone,
a portable multi-function device,
a virtual machine.

16. The system of claim 14, wherein the second computer system comprises one or combination of the following:
a personal computer,
a camera,
a cell phone,
a laptop,
a tablet PC,
a smart-phone,
a portable multi-function device,
a virtual machine.

17. The system of claim 14, wherein the device for storing data #1 and #2 is a memory of the computer system.

18. The system of claim 14, wherein the device for storing data #1 and #2 is a database located on the computer system.

19. The system of claim 14, wherein all or a part of the one or more computer systems from the first computer system group is located in the cloud environment.

20. The system of claim 14, wherein all or a part of the second computer system is located in the cloud environment.

21. The system of claim 14, wherein the one or more devices for storing data #1 are located in the cloud environment.

22. The system of claim 14, wherein the one or more devices for storing data #2 are located in the cloud environment.

23. The system of claim 14, wherein the following parts of the second computer system are located in the cloud environment: one or more processors #2, the one or more devices for storing data #2.

24. The system of claim 14, wherein one or more computer systems from the first computer system group additionally comprise an output device.
